(19) United States
(12) Patent Application Publication
(10) Pub. No.: US 2010/0292076 A1
(43) Pub. Date: Nov. 18, 2010

(54) ULTRA HIGH TEMPERATURE SHIFT CATALYST WITH LOW METHANATION

(75) Inventors: Jon P. Wagner, Louisville, KY (US); Chandra Ratnasamy, Louisville, KY (US); Maxim Lyubovsky, Fairfax, VA (US); Frank D. Lomax, Boyds, MD (US)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE INC., Louisville, KY (US)

(21) Appl. No.: 12/559,093

(22) Filed: Sep. 14, 2009

Related U.S. Application Data
(63) Continuation-in-part of application No. 12/467,731, filed on May 18, 2009, now abandoned.

(51) Int. Cl. C01B 3/02; B01J 23/10

(52) U.S. Cl. 502/304; 252/188.25

(57) ABSTRACT

A water gas shift catalyst for use at temperatures above about 450° C. up to about 900° C. or so comprising a partially reducible transition metal oxide without an active metal added thereto.

### CROSS REFERENCE TO RELATED APPLICATIONS

This application is a continuation-in-part application based on application Ser. No. 12/467,731, filed on May 18, 2009.

### TECHNICAL FIELD

The invention relates to water gas shift catalysts, particularly for use at ultra high temperatures. One embodiment of the invention is a water gas shift catalyst comprising a partially reducible transition metal oxide that remains an oxide during the water gas shift reaction. In another embodiment, no active metals, including, but not limited to, nickel, copper, cobalt, zinc, iron, chromium, molybdenum, tungsten, rhenium or precious metals, such as platinum, palladium, ruthenium, or rhodium are added to the partially reducible transition metal oxide to form the high temperature water gas shift catalyst. A further embodiment adds various dopants and/or additives to the catalyst to enhance its performance. A further embodiment is a water gas shift process using a partially reducible transition metal oxide catalyst, which process is performed at temperatures above about 450° C. up to about 900° C. and which exhibits low methanation.

### BACKGROUND ART

Conventional iron-chrome high temperature water gas shift catalyst typically operate at temperatures from 350° C. to 450° C. and have been proven to be active and stable. However, there are unique H₂ production designs being developed where active, stable and selective water gas shift catalysts are required to operate at much higher temperatures. These temperatures can occur, for example, in reforming systems that have been developed for on-site hydrogen production for industrial and high temperature fuel cell applications. In these situations the temperature for the first water gas shift stage can be as high as 900° C., thereby matching the reforming catalyst exit temperature and/or matching the temperature of the fuel cell stack. At these temperatures conventional iron-chrome catalysts exhibit accelerated activity loss due to increased sintering and degrade due to physical loss of strength due to the formation of iron carbide. When operated at these temperatures, these catalysts also are prone to make heavy hydrocarbons via a Fischer-Tropsch reaction.

On-site hydrogen production units and high temperature fuel cell power plants that utilize a fuel cell stack for producing electricity from a hydrocarbon fuel are known. One example of these power plants is a molten carbonate or a solid oxide fuel cell where the operating temperatures are from 600° C.-1000° C. With these systems, matching the water gas shift catalyst operating temperature to the reforming catalyst or fuel cell operating temperatures is beneficial as the system is simplified by elimination of heat exchangers and other associated equipment and controls.

The hydrocarbon fuel for such fuel cell stacks can be derived from a number of conventional fuel sources, with preferred fuel sources including, but not limited to, natural gas, propane and LPG.

In order for the hydrocarbon fuel to be useful in the fuel cell stack, it must first be converted to a hydrogen rich fuel stream. After desulfurization, the hydrocarbon fuel stream typically flows through a reformer, wherein the fuel stream is converted into a hydrogen rich fuel stream at temperatures up to 900° C. This converted fuel stream contains primarily hydrogen, carbon dioxide, water and carbon monoxide. The quantity of carbon monoxide can be fairly high, up to 15% or so.

Anode electrodes, which form part of the fuel cell stack, are adversely affected by high levels of carbon monoxide. Accordingly, it is necessary to reduce the quantity of carbon monoxide in the fuel stream prior to passing it to the fuel cell stack. Reduction of the quantity of carbon monoxide is typically performed by passing the fuel stream through a water gas shift converter. In addition to reducing the quantity of carbon monoxide in the fuel stream, such water gas shift converters also increase the quantity of hydrogen in the fuel stream.

Water gas shift reactors are well known and typically contain an inlet for introducing the fuel stream containing carbon monoxide into a reaction chamber, a down stream outlet, and a catalytic reaction chamber, which is located between the inlet and outlet. The catalytic reaction chamber typically contains catalytic material for converting at least a portion of the carbon monoxide and water in the fuel stream into carbon dioxide and hydrogen. The water gas shift reaction is an exothermic reaction represented by the following formula:

CO+H₂O [symbol] CO₂+H₂.

Water gas shift reactions conventionally are carried out in two stages: a high temperature stage, at temperatures typically from about 350° C. to 450° C. and a low temperature stage at temperatures typically from 180° C. to 240° C. While the lower temperature reactions favor more complete CO conversion, the higher temperature reactions allow recovery of the heat of reaction at a sufficient temperature level to generate high pressure steam.

Because of various unique operating conditions, as discussed above, water gas shift reactions sometimes occur at temperatures above 450° C. and even as high as 900° C. or so. However, at these temperatures, the excess production of methane and the formation of higher hydrocarbons, generally by a Fischer Tropsch reaction, by the water gas shift catalyst are significant issues. The methanation reaction is represented by the following formula and shows the consumption of 3 moles of hydrogen for every mole of carbon monoxide converted:

CO+3H₂ [symbol] CH₄+H₂O

In addition, conventional water gas shift catalysts are not able to physically withstand these higher operating temperatures. These high temperatures are experienced in reformer designs where the high temperature reforming steps are thermally integrated in so-called heat exchanger reactors. Such high temperatures also occur when the water gas shift catalysts are thermally integrated with high temperature fuel cells.

There are other problems experienced in fuel reformer systems where reformed gases are cooled from 900° C. to 450° C., namely metal dusting and the formation of Boudard carbon by the reaction.

2CO→CO₂+C

This Boudard reaction is very well-known, and is generally not reversible. There is a long-felt need for methods to suppress Boudard carbon formation when reformed gas mixtures are cooled, as the carbon formed poses many problems, such as plugging or fouling piping and vessels, and reacting with the materials of construction to form metal carbides, which eventually cause severe corrosion and failure.

This type of failure is called metal dusting, and is well-known in the art. Metal dusting is also caused by dehydrogenation of methane.

CH₄→2H₂+C

No satisfactory solution to the problem of metal dusting has been discovered, so prior art reforming systems rely on extremely rapid cooling of reformed gases to avoid the problem, usually by use of water injection of boiling heat transfer in a waste heat boiler. Further, extensive processing of reformed gases in the temperature range above 450° C. is almost universally-avoided. This extremely rapid cooling.

The catalyst of an alternative embodiment of the invention facilitates reaction and convective gas to gas heat transfer in the temperature range between 900° C. and 450° C., thus permitting special operational advantages in certain types of systems such as those of U.S. Pat. No. 6,497,856 and U.S. Pat. No. 6,623,719.

There are a number of water gas shift catalysts that are known in the art. For instance, known water gas shift catalysts generally contain one or more active metals such as, but not limited to, nickel, cobalt, copper, chromium, zinc, iron, molybdenum, tungsten, rhenium, or precious metals, such as platinum, palladium, rhodium or ruthenium, as the active component, deposited on a support. In one embodiment Pt and/or Ru and/or Pd and/or Rh are deposited on a conventional support. Such precious metal based water gas shift catalysts generally operate at 300° C. to 400° C. These precious metals can be quite expensive and increase the overall costs of a single charge of the water gas shift catalysts significantly.

Notwithstanding the existence of various compositions for catalysts for use in water gas shift converters, there is a need for improvement in the performance of water gas shift catalysts, particularly in stability and limitation on methanation and higher hydrocarbon production at high operating temperatures above 450° C. up to 900° C. or so. Further, improvements in the structure of these catalysts are also needed because, at these high temperatures, conventional water gas shift catalysts physically degrade or react with the reformed gas to form metal carbides or solid carbon.

In addition, when conventional water gas catalysts are modified to prevent the formation of higher molecular weight hydrocarbons and by-products, activity of the catalysts is frequently reduced.

Many precious metal water gas shift catalysts, particularly platinum, rhodium, palladium and/or ruthenium-based water gas shift catalysts, cause methanation of CO and/or CO₂ as a side reaction when operated at temperatures above about 325° C. A large percentage of the hydrogen present in the feed stream can be consumed by these methanation reactions and thereby, reduce the overall yield of hydrogen. Further, methanation of carbon oxides is accompanied by a strong exothermic reaction which causes a rapid temperature increase, thereby making control of the reaction difficult and reducing the stability of the catalyst. In addition, as these precious metal-based, water gas shift catalysts age, the amount of methane produced increases. Methanation also increases the amount of methane present, and thus encourages metal dusting corrosion by methane dehydrogenation.

Accordingly, it would be advantageous to provide an improved water gas shift catalyst that retains activity, particularly at high temperatures and has increased stability over the lifetime of the catalyst.

Moreover, it would be advantageous to provide an improved water gas shift catalyst for use at high temperatures that does not result in any substantial methanation reactions or the production of substantial quantities of higher hydrocarbons, especially after aging of the catalysts.

Additionally, it would be desirable to provide an improved water gas shift process for use at temperatures from about 450° C. to about 900° C. using a catalyst comprising a partially reducible transition metal oxide.

Further it would be advantageous to suppress metal dusting by minimizing the concentration of both methane and carbon monoxide at each operating temperature and pressure as the gas is cooled.

It is understood that the forgoing advantages are explanatory only and not restrictive of the various embodiments of the invention.

### DISCLOSURE OF EMBODIMENTS OF THE INVENTION

In accordance with one embodiment of the invention, there is provided an improved water gas shift catalyst for high temperature reactions which exhibits low methanation comprising a partially reducible transition metal oxide that remains an oxide during the water gas reaction (“partially reducible transition metal oxide”). A partially reducible oxide is defined as a metal oxide that is not completely reduced to a metallic state when exposed to hydrogen and/or carbon monoxide at temperatures from 200 to 600° C. The partial reduction can be generally described by the formula below:

Me^{(+y)}+xe⁻←→Me^{(+y-x)}

Where y=2, 3 or 4 and 0.1<x<1.0

An alternative embodiment of the invention comprises an improved water gas shift catalyst, especially for use at high temperatures, exhibiting low methanation and reduced production of higher hydrocarbons, comprising a partially reducible transition metal oxide that remains an oxide during the water gas reaction, wherein no metals are added to the catalyst to act as an active component for the water gas shift reaction.

An alternative embodiment of the invention comprises an improved water gas shift catalyst for use at high temperatures which exhibits low methanation comprising a partially reducible transition metal oxide that remains an oxide during the water gas reaction, where no active metals are deposited on the catalyst to act as an active component for the water gas shift reaction, wherein the transition metal is selected from the group consisting of cerium, neodymium, praseodymium, manganese and gadolinium.

For purposes of this disclosure “high or higher temperature” water gas shift reactions are those that occur at a temperature greater than about 450° C., generally greater than 550° C. and up to as high as about 900° C., or so.

An alternative embodiment of the invention comprises a water gas shift reaction process for use at temperatures above about 450° C., alternatively above about 550° C., up to about 900° C., whereby at least a portion of the carbon monoxide and water in a fuel stream is converted to hydrogen and carbon dioxide by utilization of a catalyst comprising a partially reducible transition metal oxide that remains an oxide during the water gas reaction, which process results in low methanation, especially after aging of the catalyst and especially where no active metals are added to the catalyst to act as an active component.

### MODES FOR CARRYING OUT EMBODIMENTS OF THE INVENTION

The water gas shift catalyst for use at high temperature of one embodiment comprises a partially reducible transition metal oxide that remains an oxide during the water gas shift reaction. In one alternative embodiment the transition metal oxides are selected from lanthanide oxides. In a further alternative embodiment, the transition metal is selected from the group consisting of cerium, neodymium, praseodymium, manganese and gadolinium.

The water gas shift catalyst for use at high temperatures of one embodiment comprises a partially reducible transition metal oxide that remains an oxide during the water gas shift reaction. The reducibility of the transition metal oxide can be determined by measurement of its hydrogen consumption measured between about 200° C. and 900° C. This measurement can be carried out by temperature-programmed reduction (“TPR”) using hydrogen diluted in an inert gas, such as argon and subjected to increasing temperature. The degree of partial reduction is determined by measuring the consumption of hydrogen while increasing the temperature from about 200° C. to 900° C. The molar ratio of hydrogen consumed relative to the amount of reducible oxide represents the degree of reduction. For example, materials such as cerium oxide will consume a noticeable amount of hydrogen by the following reaction:

2 CeO₂+H₂ [symbol] Ce₂O₃+H₂O

In contrast, materials such as TiO₂, ZrO₂ and Al₂O₃ do not consume hydrogen in this reaction and therefore are not considered reducible. The transition metal oxides of one embodiment of the invention are partially reducible, while still remaining an oxide during the water gas shift reaction.

The composition of such transition metal oxides may be improved to increase their stability by the addition of a metal oxide material, particularly a stabilizing metal oxide material. In one alternative embodiment, there is added to the partially reducible transition metal oxide that remains an oxide during the water gas shift reaction an additional metal oxide which may be selected from the following, depending on the material used as the partially reducible transition metal oxide: zirconia, ceria, titania, silica, lanthana, praseodymium oxide, neodymium oxide, yttria, samarium oxide, tungsten oxide, molybdenum oxide, calcium oxide, chromium oxide, manganese oxide, barium oxide, strontium oxide and magnesium oxide. In one alternative embodiment, the catalytic material comprises ceria as the partially reducible transition metal oxide which is blended with zirconia for stability. If the catalytic material is selected from ceria and zirconia, the preferred ratio of the zirconia to ceria should be from about 1:10 to about 10:1. Additional or alternative oxides that can be added to the partially reducible transition metal oxide are selected from transition metal oxides, such as lanthanide oxides, such as praseodymia and/or neodymia.

In another alternative embodiment, praseodymia and/or neodymia or other lanthanide oxides may be added to the ceria/zirconia catalyst. Each of the praseodymia and/or neodymia or other lanthanide oxides comprises from about 1 percent by weight to about 30 percent by weight of the additive.

The partially reducible transition metal oxide, if blended with other metal oxides, can be produced by blending together the metal oxides using conventional procedures or the mixed metal oxides can be purchased from conventional sources separately or after combination of the separate metal oxides.

To form the catalyst, the metal oxide materials, if multiple materials are used, are physically mixed by conventional procedures. Conventional liquids, such as water and/or acetic acid are preferably added to the high surface area materials to permit them to be processed, for example, by extrusion, to form extrudates, or to form tablets, or to form a slurry to be washcoated on a conventional monolith or other substrate.

In an alternative embodiment, no active metal component is added to the catalysts of the invention. (For purposes of this disclosure “active metals” are metals in their elemental state and do not include, for example, metal oxides, such as partially reducible metal oxides of cerium, neodymium, praseodymium, manganese and gadolinium.) Many prior art water gas shift catalysts have contained as an active metal component one or more metals including, but not limited to, nickel, cobalt, copper, zinc, iron, chromium, molybdenum, tungsten, rhenium, and precious metals, preferably platinum, rhodium, palladium and/or ruthenium. For purposes of this disclosure, “precious metals” include gold, silver, platinum, palladium, iridium, rhodium, osmium, and ruthenium.

The inventors have surprisingly discovered that when water gas shift catalysts containing these metals, or other conventional active metals of earlier water gas shift catalysts, are utilized in water gas shift reactions conducted at temperatures of the feedstream greater than about 325° C., and certainly at temperatures greater than 450° C., especially when precious metals are used, methane is often produced by the catalysis of CO or CO₂ with hydrogen. The production of methane during the water gas shift reaction is a side reaction that reduces the quantity of hydrogen that is present in the feed stream and also increases the temperature of the feedstream, because the methanation reaction is highly exothermic. Because hydrogen production is diminished by this methanation reaction, the methanation reaction is a major disadvantage of the use of conventional water gas shift catalysts at high temperatures. This problem of methanation is particularly important as the active metal-based catalysts age.

The inventors have surprising discovered that when active metals are not utilized with the catalyst and the catalyst includes a partially reducible transition metal oxide, the production of methane is substantially reduced and the CO conversion is maintained at adequate levels when the temperature of the WGS reaction is greater than about 450° C., particularly when it is greater than 550° C., up to about 900° C. or so. This result is especially noticeable as the catalyst ages. This was a surprising result and unanticipated as it was assumed that a catalyst without an active metal material, including, but not limited to, precious metals, copper, iron, chromium, nickel, cobalt, zinc, molybdenum, tungsten, or other typical water gas shift catalyst active metals would not react in a similar manner to prior art metal-based water gas shift catalysts. Thus, in an alternative embodiment the catalyst of the invention does not include any active metals, even though such active metals, have been utilized on high temperature water gas shift catalysts of the prior art.

The inventors have also surprisingly discovered that when these active metals are removed from WGS catalysts, the levels of higher hydrocarbons may also be reduced when the water gas reaction occurs at high temperatures greater than about 325° C., especially at temperatures above about 450° C.

In an alternative embodiment, an alkali or alkaline earth metal oxide may be added to the catalyst as a dopant, preferably comprising from about 0.1 to about 10% by weight, and more preferably 1.0 to 1.5%, by weight of the support. In an further alternative embodiment, the dopant is an alkali metal oxide selected from sodium, potassium, cesium and rubidium oxides and mixtures thereof with sodium and/or potassium oxides particularly preferred. When an alkali or alkaline earth metal dopant is added, it can be added to the catalyst after formation or it can be combined with the other components of the catalyst at any stage in the processing of the catalyst. The dopant can be added by conventional procedures, such as impregnation. In a preferred embodiment, the alkali or alkaline earth metal dopant is impregnated into the catalyst after formulation.

After formation of the water gas shift catalyst, its surface area is preferably at least about 30 m²/g, more preferably from about 40 to about 150 m²/g.

The water gas shift catalyst of these embodiments preferably is produced in the form of moldings, especially in the form of spheres, pellets, rings, tablets or extruded products, in which the later are formed mostly as solid or hollow objects in order to achieve higher geometric surfaces with a simultaneously low resistance to flow. Alternatively, monoliths, or other substrates, are coated with the catalytic materials as alternative embodiments.

The catalyst is employed in a process in which carbon monoxide and steam are converted to hydrogen and carbon dioxide at a temperature above 450° C., alternatively above 550° C., and up to about 900° C. or so and under pressures above atmospheric pressure, alternatively above about 50 psi (3.4 bar), alternatively above about 100 psi (6.9 bar), and alternatively above about 150 psi (10.3 bar) up to about 600 psi, (41 bar) or so.

In an alternative embodiment the carbon monoxide comprises from about 1 to about 15% of the feed stream and the molar ratio of the steam to the dry gas is from about 0.1 to about 5.

It has surprisingly been discovered that there is adequate CO conversion in comparison to the performance of conventional water gas shift catalysts when the catalysts of the disclosed embodiments are used at high temperatures with a significant reduction in methanation and other hydrocarbon by-products.

It has also been surprisingly discovered that adequate water gas shift activity is retained even without the presence of active metals on the catalyst.

It has also surprisingly been discovered that catalysts of the invention retain adequate water gas shift conversions even at temperatures greater than 450° C. with reduced methanation, even when the temperature of the feedstream approaches 900° C. or so.

It has also been surprisingly discovered that catalysts of the invention retain adequate water gas shift conversions at temperatures greater than 450° C. with reduced methanation, even when the temperature of the feed stream approaches 900° C. or so and even after repeated utilizations. In fact, it has been surprising that aged catalysts of the invention produce adequate water gas shift reactions with especially reduced methanation after the catalysts have been used on stream for significant periods of time.

It has also been discovered that such catalysts operate without any carbon formation or metal dusting of the structural metals of construction.

### EXAMPLES

Catalysts in the form of tablets are produced for testing in a reactor. Many of the catalysts are based on a ceria/zirconia tablet. (In Example 2, the fourth and fifth catalyst use zirconia as the support material in tablet form.) For some of the catalysts, the ceria/zirconia tablet is the catalytic material. In other tablets a quantity of rhenium is added by a conventional impregnation procedure to either the ceria/zirconia tablet or the zirconia support. The ceria/zirconia tablet is purchased from a conventional supplier and comprises 80% ceria and 20% zirconia. The zirconia tablet is also purchased from a conventional supplier. When rhenium is impregnated onto either the ceria/zirconia tablet or the zirconia support, the quantity varies, as discussed below, and is by weight.

### Example 1

### Fresh Water Gas Shift Catalyst Activity

A water gas shift reaction for each catalyst is run at varying temperatures. The Re/CZO catalyst contains 0.4% rhenium, by weight. A water gas shift reaction for each catalyst is run at varying temperatures and at a pressure of 180 psig (12.4 bar). The conditions of the reactor are a dry gas inlet comprising 10% CO, 10% CO2, and 80% H2. The steam/dry gas ratio equals 0.6. The DGSV=180,000 l/hr. The results are shown in the following Table 1 and are for fresh catalysts. The first column of Table 1 shows the temperature of the water gas shift reaction. The second column shows the percent of CO conversion by the ceria/zirconia catalyst at different temperatures. The third column shows the percentage of CO conversion for the Re/CZO catalyst at different temperatures.

TABLE 1
Fresh Catalyst CO Conversion

| Temp, C. | CZO | Re/CZO |
|---|---|---|
| 350 | 1.5% | 3.0% |
| 450 | 7.6% | 14.3% |
| 550 | 17.1% | 20.1% |

### Example 2

### Fresh Catalyst, Methane Production and Water Gas Shift Activity

Compared is the performance of five fresh catalysts. The first catalyst comprises the ceria/zirconia catalyst of Example 1. The second and the third catalyst comprise two quantities of rhenium, by weight, impregnated on the ceria/zirconia catalyst, as described in Example 1. The fourth and the fifth catalyst comprise rhenium impregnated upon the zirconia support, by weight. A water gas shift reaction for each catalyst is run at 350° C. and 600° C. The CO conversion is determined at 350° C. while the percentage of methane produced is determined at 600° C. The conditions of the reactor are a dry gas inlet comprising 10% CO, 16% CO₂, 11% N₂, and 63% H₂. The steam/dry gas ratio equals 0.6. The pressure is 50 psig (3.4 bar) with a DGSV of 20,000 l/hr. The results are shown in the following Table 2.

TABLE 2
Fresh Catalyst CO Conversion and Methane Production

| | % CO conv | % CH4 |
|---|---|---|
| Sample | at 350° C. | at 600° C. |
| CZO | 2.4% | <0.05% |
| 0.4% Re/CZO | 15.1% | 0.55% |
| 0.8% Re/CZO | 19.8% | 1.32% |
| 0.5% Re/ZrO₂ | 5.4% | 0.80% |
| 1.0% Re/ZrO₂ | 8.1% | 2.70% |

### Example 3

### Aged Catalyst, Methane Production and Water Gas Shift Activity

The catalysts of Example 1 are produced and tested at four different temperatures of 500° C., 600° C., 700° C. and 800° C. after aging. The catalysts are tested for CO conversion and methane production in the exit gas. The conditions of the reactor are 10% CO, 10% CO2 and 80% H2 with a steam/dry gas ratio of 0.6. The pressure is 180 psig (12.4 bar) with a DGSV of 180,000 l/hr. To approximate the aging of the catalysts, the catalysts are run for 1,000 hours under the disclosed conditions. The results are shown in the following Table 3.

TABLE 3
Aged Catalyst CO and Methane Exit Gas Concentration
(dry gas)

| Temp, | CZO | CZO | Re/CZO | Re/CZO |
|---|---|---|---|---|
| C. | % CO | % CH4 | % CO | % CH4 |
| 500 | 9.6% | 0.05% | 8.2% | 0.05% |
| 600 | 8.4% | 0.12% | 7.3% | 0.19% |
| 700 | 8.2% | 0.12% | 7.9% | 0.45% |
| 800 | 9.2% | 0.12% | 9.6% | 0.38% |

Accordingly, the inventors have discovered that catalysts comprising a partially reducible transition metal oxide wherein the metal remains an oxide during the water gas shift reaction even when operated at high temperatures retained adequate water gas shift activity with low methanation and reduced production of higher hydrocarbons in comparison to metal-based WGS catalysts.

### INDUSTRIAL APPLICABILITY

The above described catalysts and processes can be used in reforming systems that have been developed for on site hydrogen production for industrial and high temperature fuel cell applications.

Although one or more embodiments of the invention have been described in detail, it is clearly understood that the descriptions are in no way to be taken as limitations. The scope of the invention can only be limited by the appended claims.

1. A water gas shift catalyst comprising a partially reducible transition metal oxide that remains an oxide during a water gas shift reaction at temperatures from about 450° C. to about 900° C.

2. The water gas shift catalyst of claim 1 wherein the partially reducible transition metal oxide is selected from the group consisting of cerium, neodymium, praseodymium, gadolinium, and manganese.

3. The water gas shift catalyst of claim 1 wherein the partially reducible transition metal comprises cerium.

4. The water gas shift catalyst of claim 1 wherein the partially reducible transition metal oxide is combined with a metal oxide selected from the group consisting of zirconia, lanthana, praseodymium oxide, neodymium oxide, yttria, titania, silica, samarium oxide, tungsten oxide, molybdenum oxide, calcium oxide, chromium oxide, magnesium oxide, barium oxide, strontium oxide, and mixtures thereof.

5. The water gas shift catalyst of claim 1 wherein the catalyst does not include an active metal deposited upon or combined with the partially reducible transition metal oxide.

6. The water gas shift catalyst of claim 5 wherein the active metal that is not included with the partially reducible transition metal oxide is selected from the group consisting of precious metals, rhenium, iron, chromium, copper, cobalt, nickel, molybdenum, zinc and tungsten.

7. The water gas shift catalyst of claim 1, wherein the catalyst does not include an active precious metal selected from the group consisting of platinum, palladium, rhodium, ruthenium, iridium, osmium, silver, gold and mixtures thereof.

8. The water gas shift catalyst of claim 1 wherein the partially reducible transition metal oxide comprises ceria, which is combined with zirconia.

9. The water gas shift catalyst of claim 8 wherein the catalyst further comprises praseodymium oxide and/or neodymium oxide.

10. The water gas shift catalyst of claim 1 further comprising an alkali or alkaline earth metal dopant.

11. The water gas shift catalyst of claim 10, wherein the dopant is selected from the group of consisting of sodium, potassium, cesium, and rubidium oxides and mixtures thereof.

12. The water gas shift catalyst of claim 10, wherein the alkali or alkaline earth dopant comprises from about 0.1 to about 10% of the catalyst, by weight.

13. A water gas shift process comprising preparing a feed stream containing carbon monoxide and steam and passing that feed stream over a water gas shift catalyst comprising a partially reducible transition metal oxide, wherein the metal oxide remains an oxide during the water gas shift reaction, at a pressure above about 50 psi, (3.4 bar) and at a temperature of about 450° C. up to about 900° C.

14. The process of claim 13 wherein the quantity of carbon monoxide is between about 1 and 15% and a molar steam to dry gas ratio is from about 0.1 to about 5.

15. The process of claim 14 wherein the water gas shift catalyst does not include an active metal deposited or combined with the partially reducible transition metal oxide.

16. The process of claim 13 wherein the catalyst does not include a precious metal selected from the group consisting of platinum, palladium, rhodium, ruthenium, iridium, osmium, silver, gold and mixtures thereof.

17. The process of claim 13 wherein the partially reducible transition metal oxide is selected from the group consisting of cerium, neodymium, praseodymium, gadolinium, and manganese.

18. The process of claim 13 wherein the partially reducible transition metal comprises cerium.
